(19) United States
(12) Patent Application Publication
(10) Pub. No.: US 2026/0302586 A1
(43) Pub. Date: Oct. 1, 2026

(54) RADIO FREQUENCY ADJUSTMENT STRUCTURE REDUCING INFLUENCE OF METAL DEBRIS

(71) Applicant: Suzhou Luxshare Technology Co., Ltd., Suzhou City (CN)

(72) Inventors: Zhen-guo SONG, Suzhou City (CN); Shao-dong LI, Suzhou City (CN); Xu LIU, Suzhou City (CN); Xing-liao NING, Suzhou City (CN)

(73) Assignee: Suzhou Luxshare Technology Co., Ltd., Suzhou City (CN)

(21) Appl. No.: 19/374,353

(22) Filed: Oct. 30, 2025

(30) Foreign Application Priority Data
Mar. 31, 2025 (CN) 202520581101.6

(51) Int. Cl. H01P 7/06

(52) U.S. Cl. CPC H01P 7/06

(57) ABSTRACT

A radio frequency adjustment structure includes: a box base, a cover plate, an adjustable screw rod, and a debris collection component. The cover plate includes a top surface and a bottom surface oppositely facing in a vertical direction. The cover plate has a through hole communicating the top surface with the bottom surface along the vertical direction. The adjustable screw rod is positioned to the cover plate, penetrates through the through hole by means of partially extending beyond the top surface, and partially extends below the bottom surface. The debris collection component includes a first component and a second component. The first component is disposed at a circular position surrounding the through hole of the cover plate. The first component is exposed out of the bottom surface of the cover plate and the second component is disposed just below the first component in the vertical direction.

### CROSS-REFERENCE TO RELATED APPLICATION

This patent application claims priority of a Chinese Patent Application No. 202520581101.6, filed on Mar. 31, 2025 and titled “RADIO FREQUENCY ADJUSTMENT STRUCTURE”, the entire content of which is incorporated herein by reference.

### TECHNICAL FIELD

The present disclosure relates to a field of radio frequency, particularly to a radio frequency adjustment structure reducing influence of metal debris.

### BACKGROUND

In an existing radio frequency (RF) adjustment structure in a RF field, an adjustable screw rod extends into a cover plate through a mutual cooperation between an inner thread and an outer thread. The adjustable screw rod is suspended and installed on the cover plate. Frequency is adjusted by adjusting different depths of the screw rod extending below the cover plate. However, since the cover plate is provided with a through hole through which the adjustable screw rod penetrates, debris generated by spiral fit between the internal thread and the external thread easily falls into the cavity below the cover plate through the through hole. Therefore, in the conventional RF modulation structure, debris accumulated in the cavity for a long time may affect the frequency modulation effect of the RF modulation structure.

### SUMMARY

An embodiment of the present disclosure adopts the following technical solution: a radio frequency adjustment structure, including: a box base; a cover plate covering the box base to define a functional cavity between the cover plate and the box base, the cover plate including a top surface facing away from the functional cavity and a bottom surface facing the functional cavity for defining a vertical direction, the cover plate defining a through hole communicating the top surface with the bottom surface along the vertical direction; an adjustable screw rod being positioned to the cover plate, penetrating through the through hole, and partially extending into the functional cavity; and a debris collector including a first component and a second component, the first component being disposed at a position corresponding to the through hole of the cover plate and extending beyond the bottom surface toward the functional cavity, the first component surrounding the adjustable screw rod, and the second component being disposed just below the first component in the functional cavity.

An embodiment of the present disclosure adopts the following technical solution: a radio frequency adjustment structure, including: a cover plate, the cover plate including a top surface and a bottom surface oppositely facing in a vertical direction, the cover plate defining a through hole communicating the top surface with the bottom surface along the vertical direction; an adjustable screw rod being positioned to the cover plate and penetrating through the through hole by means of partially extending beyond the top surface and partially extending below the bottom surface; and a debris collection component including a first component and a second component, the first component being disposed at a circular position surrounding the through hole of the cover plate, the first component being exposed out of the bottom surface of the cover plate and the second component being disposed just below the first component in the vertical direction.

### BRIEF DESCRIPTION OF DRAWINGS

FIG. 1 is a perspective, assembled view of a radio frequency (RF) adjustment structure in accordance with an embodiment of the present disclosure;

FIG. 2 is a top view of the RF adjustment structure in accordance with the embodiment of the present disclosure;

FIG. 3 is an assembled sectional view taken along line A-A in FIG. 2 in accordance with a first embodiment of the RF adjustment structure of the present disclosure;

FIG. 4 is an exploded sectional view taken along line A-A in FIG. 2 in accordance with the first embodiment of the RF adjustment structure of the present disclosure;

FIG. 5 is an assembled sectional view taken along line A-A in FIG. 2 in accordance with a second embodiment of the RF adjustment structure of the present disclosure;

FIG. 6 is an exploded sectional view taken along line A-A in FIG. 2 in accordance with the second embodiment of the RF adjustment structure of the present disclosure;

FIG. 7 is an assembled sectional view taken along line A-A in FIG. 2 in accordance with a third embodiment of the RF adjustment structure of the present disclosure;

FIG. 8 is an exploded sectional view taken along line A-A in FIG. 2 in accordance with the third embodiment of the RF adjustment structure of the present disclosure;

FIG. 9 is an assembled sectional view taken along line A-A in FIG. 2 in accordance with a fourth embodiment of the RF adjustment structure of the present disclosure;

FIG. 10 is an exploded sectional view taken along line A-A in FIG. 2 in accordance with the fourth embodiment of the RF adjustment structure of the present disclosure;

FIG. 11 is an assembled sectional view taken along line A-A in FIG. 2 in accordance with a fifth embodiment of the RF adjustment structure of the present disclosure;

FIG. 12 is an exploded sectional view taken along line A-A in FIG. 2 in accordance with the fifth embodiment of the RF adjustment structure of the present disclosure;

FIG. 13 is an assembled sectional view taken along line A-A in FIG. 2 in accordance with a sixth embodiment of the RF adjustment structure of the present disclosure;

FIG. 14 is an exploded sectional view taken along line A-A in FIG. 2 in accordance with the sixth embodiment of the RF adjustment structure of the present disclosure;

FIG. 15 is a cross-sectional view of a first component in accordance with a first implementation mode of the present disclosure;

FIG. 16 is a cross-sectional view of the first component in accordance with a second implementation mode of the present disclosure;

FIG. 17 is a cross-sectional view of a second component in accordance with a first implementation mode of the present disclosure;

FIG. 18 is a cross-sectional view of the second component in accordance with a second implementation mode of the present disclosure; and

FIG. 19 is a cross-sectional view of the second component in accordance with a third implementation mode of the present disclosure.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

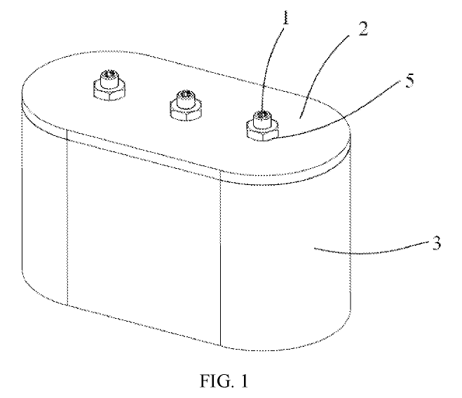

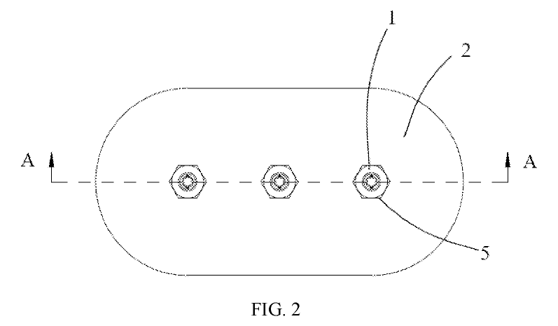

Referring to FIGS. 1 to 14, the present disclosure discloses a radio frequency (RF) adjusting structure, which includes an adjustable screw rod 1, a cover plate 2, a box base 3 and a debris collector 4. The cover plate 2 covers the box base 3 and a functional cavity 30 is formed between the cover plate 2 and the box base 3. The cover plate 2 includes a top surface 201 facing away from the functional cavity 30 and a bottom surface 202 facing toward the functional cavity 30 so as to define a vertical direction. The cover plate 2 extends in a horizontal direction perpendicular to the vertical direction. The cover plate 2 defines a through hole 20 vertically communicating with the top surface 201 and the bottom surface 202. The adjustable screw rod 1 is positioned with the cover plate 2 and passes through the through hole 20 and partially extends into the functional cavity 30. The debris collector 4 includes a first component 41 and a second component 42. The first component 41 is disposed on the cover plate 2 at a position corresponding to the through hole 20. The first component 41 is exposed out of the bottom surface 202 of the cover plate 2, extends toward the functional cavity 30, and is annularly disposed around and outside the adjustable screw rod 1. The second component 42 is disposed just below the first component 41 in the vertical direction. Therefore, the present disclosure includes a first component 41 having a function of guiding debris from the through hole 20 and a second component 42 having a function of collecting debris guided from the first component 41. The first component 41 is a debris passage and the second component 42 is a target for debris. Through the cooperation of the first component 41 and the second component 42, the RF adjusting structure disclosed in the present disclosure reduces debris falling into the functional cavity 30 below the cover plate 2, improves intermodulation, and optimizes the frequency modulation effect.

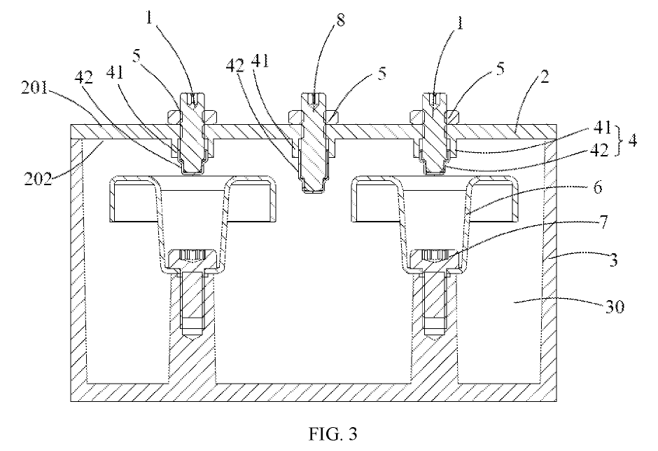

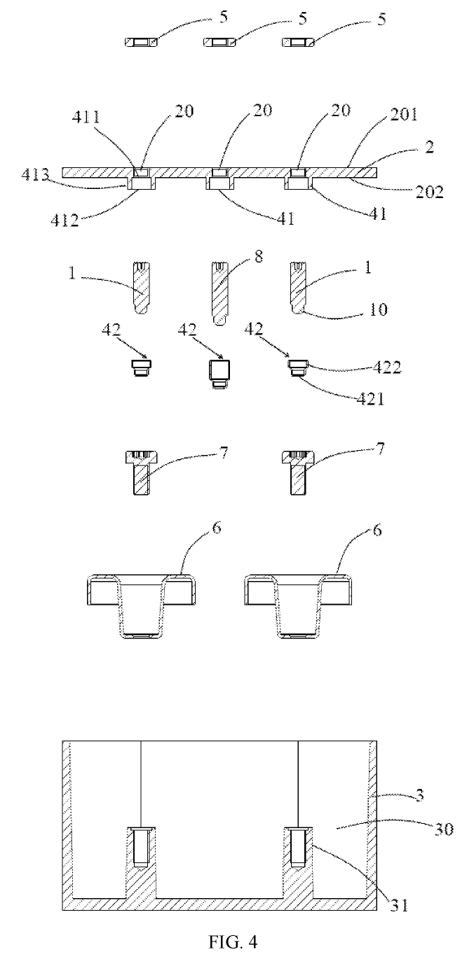

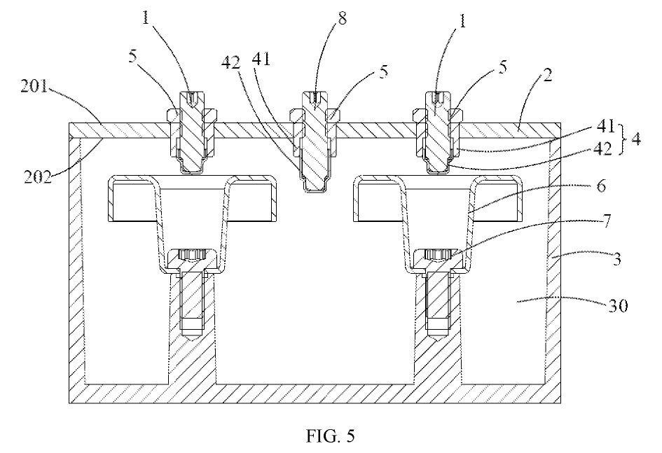

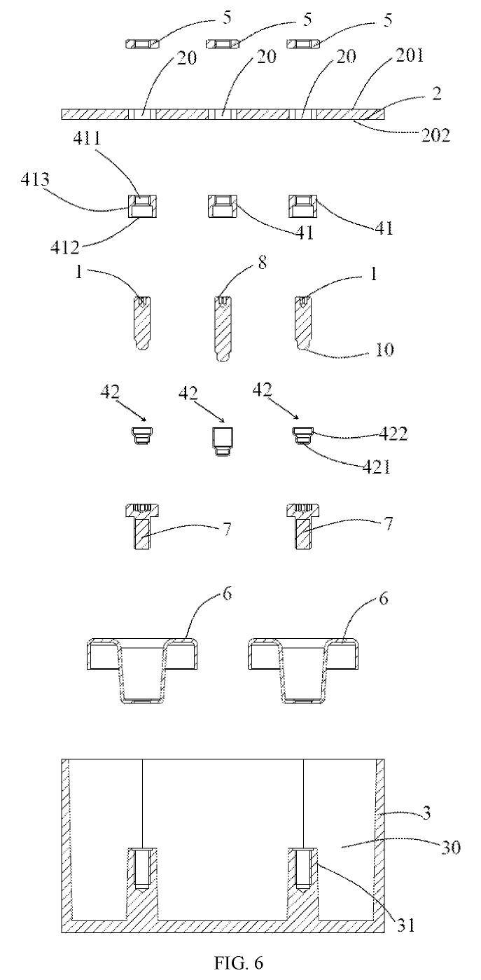

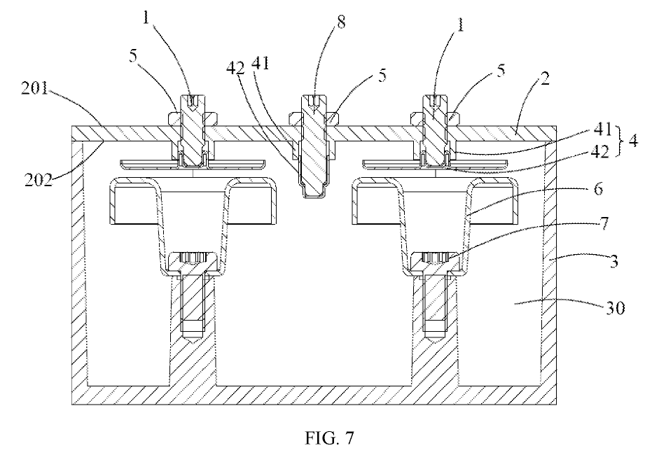

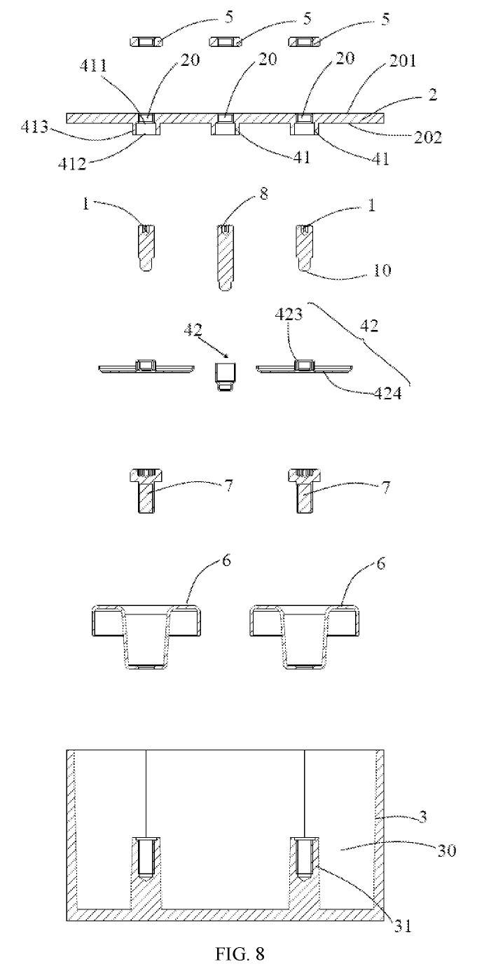

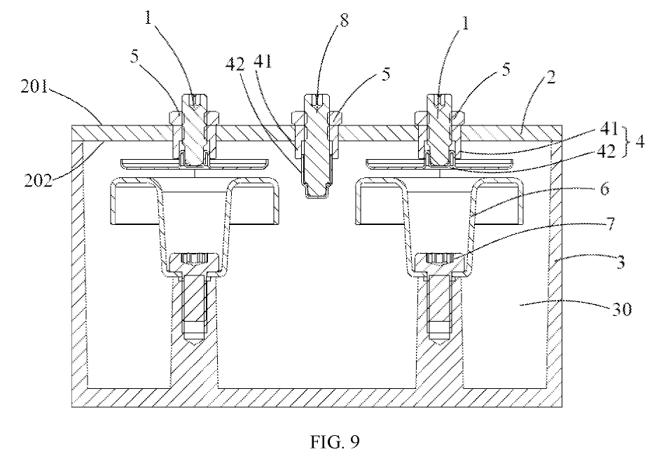

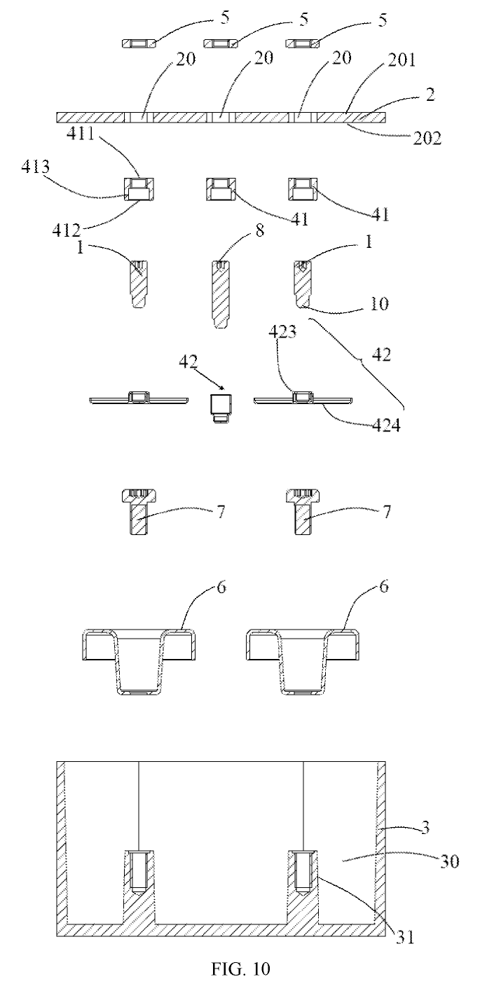

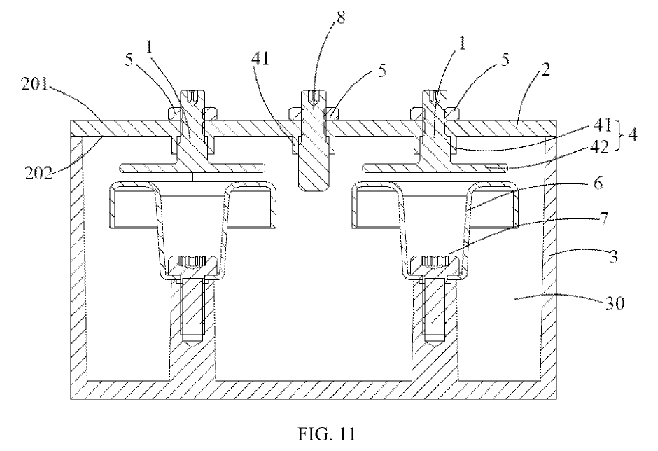

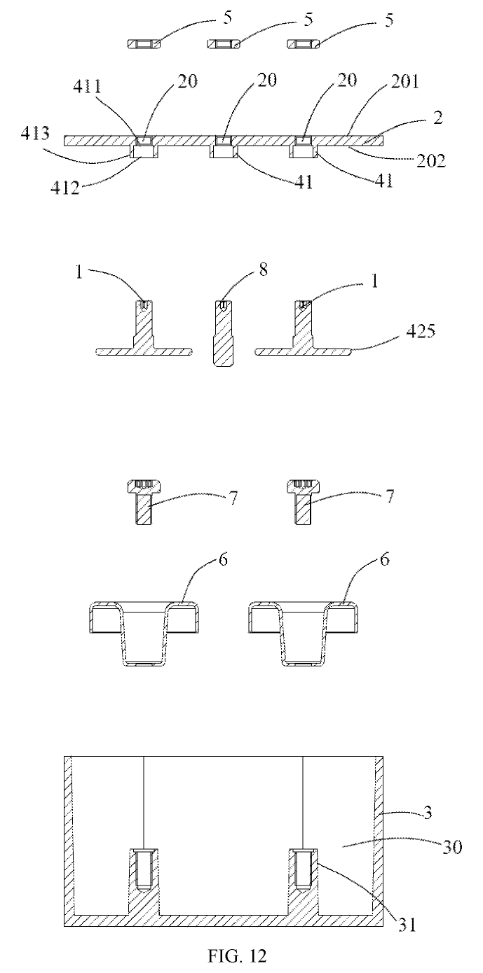

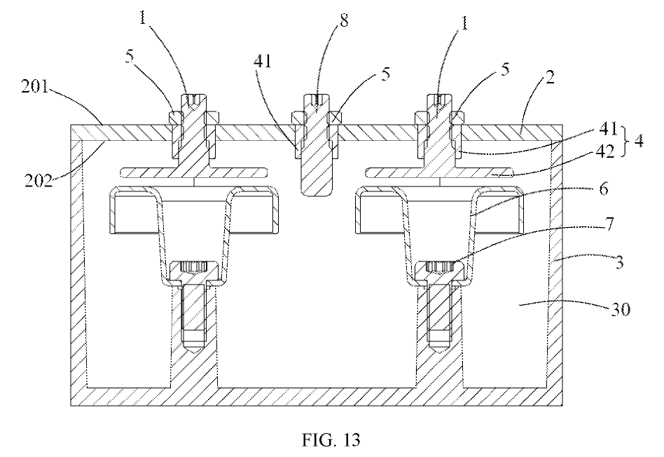

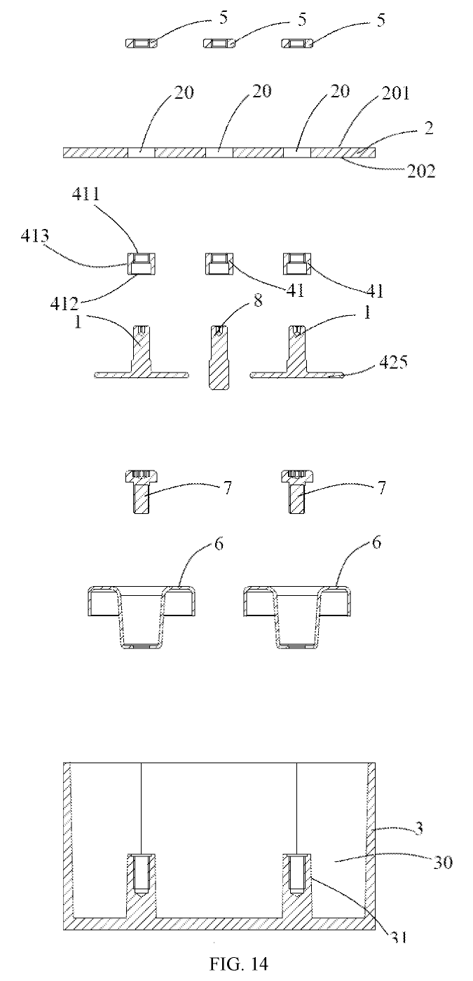

Referring to a first embodiment shown in FIGS. 3 and 4, a third embodiment shown in FIGS. 7 and 8, and a fifth embodiment shown in FIGS. 11 and 12, the first component 41 includes a sidewall annular portion 413 integrally protruding from the bottom surface 202 of the cover plate 2. Referring to a second embodiment shown in FIGS. 5 and 6, a fourth embodiment shown in FIGS. 9 and 10, and a sixth embodiment shown in FIGS. 13 and 14, the first component 41 includes a sidewall annular portion 413 separately secured to the bottom surface 202 of the cover plate 2. The sidewall annular portion 413 includes a top opening 411 and a bottom opening 412 disposed oppositely there-through and includes an upper portion adjacent to the top opening 411 and a lower portion adjacent to the bottom opening 412. That is to say, when the first component 41 and the cover plate 2 in the first, third and fifth embodiments are integrally molded, the entire sidewall annular portion 413 protrudes directly from the bottom surface 202 toward the functional cavity 30. When the first component 41 and the cover plate 2 in the second, fourth and sixth embodiments are separately molded, the upper portion of the sidewall annular portion 413 is further press-riveted into the through hole 20 while the lower portion of the sidewall annular portion 413 is exposed out of the through hole 20 and disposed toward the functional cavity 30 from the bottom surface 202. The sidewall annular portion 413 not only guides debris from the through hole 20, but also blocks the debris, let the debris follow along a specific track downward, and further fall into the second component 42 having a collecting function. Regardless of whether the sidewall annular portion 413 in the first embodiment, the third embodiment, and the fifth embodiment is integrally convexly provided or the sidewall annular portion 413 in the second embodiment, the fourth embodiment, and the sixth embodiment is separately and fixedly provided, the sidewall annular portion 413 includes a top opening 411 and a bottom opening 412 which are oppositely arranged so as to facilitate the rotational cooperation between the first component 41 and the adjustable screw rod 1, The significance of the bottom opening 412 is to the possibility of arranging the second component 42 below the first component 41. Thus, in the present disclosure, the first component 41 has ceased to function as a containment body for debris but becomes a passage for debris.

Referring to the second embodiment shown in FIGS. 5 and 6, the fourth embodiment shown in FIGS. 9 and 10, and the sixth embodiment shown in FIGS. 13 and 14, when the first component 41 is separately secured to the bottom surface 202 of the cover plate 2, part of the first component 41 is also riveted and embedded in the through hole 20. Specifically, the upper portion of the sidewall annular portion 413 is also riveted and embedded in the through hole 20. The first component 41 is partially installed in the through hole 20 of the cover plate 2 by using the press-in riveting and embedding method, and the first component 41 is easy to replace when damaged.

Referring to FIGS. 1-14, the adjustable screw rod 1 includes a distal end portion 10 and the second component 42 is connected to the distal end portion 10. The second component 42 is fixedly connected or integrally connected to the terminal portion 10. In FIGS. 3 to 10, the second component 42 and the adjustable screw rod 1 are fixedly connected. In FIGS. 11 to 14, the second component 42 and the adjustable screw rod 1 are integrally connected. Both of the above two methods can ensure that the second component 42 rotates together with the adjustable screw rod 1. Therefore, whether the first component 41 is integrally protruded or separately assembled on the cover plate 2, there is a relative rotational movement between the second component 42 and the first component 41

Referring to the first embodiment shown in FIGS. 3 and 4, the second embodiment shown in FIGS. 5 and 6, the third embodiment shown in FIGS. 7 and 8, and the fourth embodiment shown in FIGS. 9 and 10, when the second component 42 is fixedly connected to the distal end portion 10, the second component 42 is partially inserted into the bottom opening 412. The fixed connection between the second component 42 and the distal end portion 10 is welding in a specific implementation mode. The second component 42 is partially inserted into the bottom opening 412. In the first to fourth embodiments, the bottom opening 412 is blocked by partially inserting the second component 42 into the bottom opening 412. The insertion and blocking means that it becomes simple and easy to connect the second component 42 below the first component 41, and the superposition of the two components (the first component 41 and the second component 42) also saves upper and lower space, thus achieving the effect of preventing leakage of continuous debris. However, the specific forms of blocking are different, which will be described in detail below.

Referring to the first embodiment shown in FIGS. 3 and 4 and the second embodiment shown in FIGS. 5 and 6, the bottom of the second component 42 is bowl-shaped. The second component 42 includes a bottom bowl portion 421 and an annular sidewall portion 422 integrally extending upward from a top edge of the bottom bowl portion 421 and spaced apart from the adjustable screw rod 1. The bottom bowl portion 421 wraps around the end portion 10 and is secured to the end portion by welding. The inner and outer surfaces of the annular sidewall portion 422 and the sidewall annular portion 413 are in close contact, achieving a connection effect. Therefore, in the first and second embodiments, the upper part of the second component 42 except for the bottom bowl portion 421, that is, the annular sidewall portion 422 is inserted into the bottom opening 412 to connect another second component 42 below the first component 41. It should be emphasized that the inner and outer joints between the annular sidewall portion 422 and the sidewall annular portion 413 in the first and second embodiments are tight joints without gaps in an ideal state; Since the bottom bowl portion 421 covers and positions the distal end portion 10 and is (welded) secured to the end portion by welding, the second component 42 is fixed with the adjustable screw rod 1, that is, during the frequency modulation process, the adjustable screw rod 1 and the second component 42 are fixed, and there is relative rotation movement between the adjustable screw rod 1 and the first component 41. Therefore, it can be understood that there is relative rotational movement between the second component 42 and the first component 41. The annular sidewall portion 422 is tightly fitted to the sidewall annular portion 413, but not fixed. Due to the tight fit between the annular sidewall portion 422 and the sidewall annular portion 413 in an ideal state and the presence of the bottom bowl portion 421, debris does not fall into the functional cavity 30, improving intermodulation and optimizing frequency modulation effect. In a non-ideal state, although the annular sidewall portion 422 and the sidewall annular portion 413 are tightly attached, a small amount of debris may still fall into the functional cavity 30 of the RF regulating structure of the present disclosure if they are not fixed. Therefore, inventors of the applicant continue to develop the following the third embodiment as a further supplement to the first embodiment; inventors of the applicant continue to develop the following the fourth embodiment as a further supplement to the second embodiment.

Referring to the third embodiment shown in FIGS. 7 and 8 and the fourth embodiment shown in FIGS. 9 and 10, when the bottom of the second component 42 is plate-shaped, the second component 42 includes an annular protrusion portion 423 located at a central thereof and a round plate portion 424 extending outward from a bottom end of the annular protrusion portion 423. The annular protrusion portion 423 includes an inner annual wall 4231, an outer annual wall 4232 and an arc-shaped portion 4233. a top end of the inner annual wall 4231 and a top end of the outer annual wall 4232 are connected by the arc-shaped portion 4233, and the round plate portion 424 is connected to the outer annual wall 4232. Therefore, the round plate portion 424 is a lateral extension of the annular protrusion portion 423 in the radial direction, used for receiving debris in a wider range. The inner annual wall 4231 is maintained in contact with the outer wall surface of the adjustable screw rod 1, and the outer annual wall 4232 is maintained in contact with the inner wall surface of the top opening 411, achieving the effect of connecting the second component 42 to the bottom of the first component 41, that is, an effect of the connection between the upper and lower parts of the debris collector 4 is achieved. Therefore, the third embodiment is the same as the first embodiment and the fourth embodiment is the same as the second embodiment in that the adjustable screw rod 1 and the second component 42 are fixed, and there is relative rotation between the adjustable screw rod 1 and the second component 42 and the first component 41. Therefore, it can be understood that there is relative rotational movement between the second component 42 and the first component 41, and although the annular sidewall portion 422 and the sidewall annular portion 413 are tightly fitted, ideally without gaps, they are not fixed. The difference between the third embodiment and the first embodiment and the fourth embodiment and the second embodiment lies in that in the third and fourth embodiments, the annular protrusion portion 423 is inserted into the bottom opening 412 and welded and secured to the terminal portion 10. Because the outer annual wall 4232 is ideally attached to the inner wall surface of the sidewall annular portion 413 without gaps, debris will not fall into the functional cavity 30, intermodulation is improved, and frequency modulation effect is optimized. It can be understood that there is relative rotation between the second component 42 and the first component 41, and even if a small amount of debris falls from the gap between the outer annual wall 4232 and the inner wall surface of the sidewall annular portion 413, the small amount of debris falls onto the round plate portion 424 instead of falling into the functional cavity 30 of the RF regulating structure of the present disclosure.

It can be understood that a specific implementation Mode of the bowl shape is stamping; in other implementation modes, the bowl shape can also be stretch formed. A specific implementation mode of the disc shape is stretch forming; in other implementation modes, the disc shape may also be stamped forming. In other words, the second component 42 as a whole is formed by one of stamping and drawing, and the bottom of the second component 42 is formed into one of a bowl shape and a disk shape during stamping or drawing of the second component 42.

On the basis of the third embodiment, inventors of the applicant continue to develop the following the fifth embodiment as a variant implementation mode of the third embodiment; on the basis of the fourth embodiment, inventors of the applicant continue to develop the following the sixth embodiment as a variant implementation mode of the fourth embodiment.

Referring to the fifth embodiment shown in FIGS. 11 and 12 and the sixth embodiment shown in FIGS. 13 and 14, when the second component 42 is integrally connected with the terminal portion 10, the second component 42 is a debris-blocking flat portion 425 integrally stamped from the terminal portion 10, and the debris-blocking flat portion 425 is spaced below the bottom opening 412. The fifth embodiment is identical to the third embodiment and the sixth embodiment is identical to the fourth embodiment in that both of them are provided with two parts, i.e., a first component 41 at the upper part and a second component 42 at the lower part, the second component 42 is provided with a disk (a round plate portion 424 in the third and fourth embodiments and a debris-blocking flat portion 425 in the fifth and sixth embodiments), the first component 41 is fixed and the second component 42 can rotate along with the adjustable screw rod 1. the fifth embodiment differs from the third embodiment, and the sixth embodiment differs from the fourth embodiment in that: In the fifth and sixth embodiments, the second component 42 is a debris-blocking flat portion 425 integrally formed by punching from the tip portion 10. Therefore, the first component 41 and the second component 42 in the fifth and sixth embodiments are not in contact with each other, and the second component 42 is not inserted into the bottom opening 412 of the first component 41. Therefore, after debris are guided from the through hole 20 to the first component 41, and falls all the way down to the debris-blocking flat portion 425 of the second component 42 through the bottom opening 412, but does not fall into the functional cavity 30 of the RF regulating structure of the present disclosure.

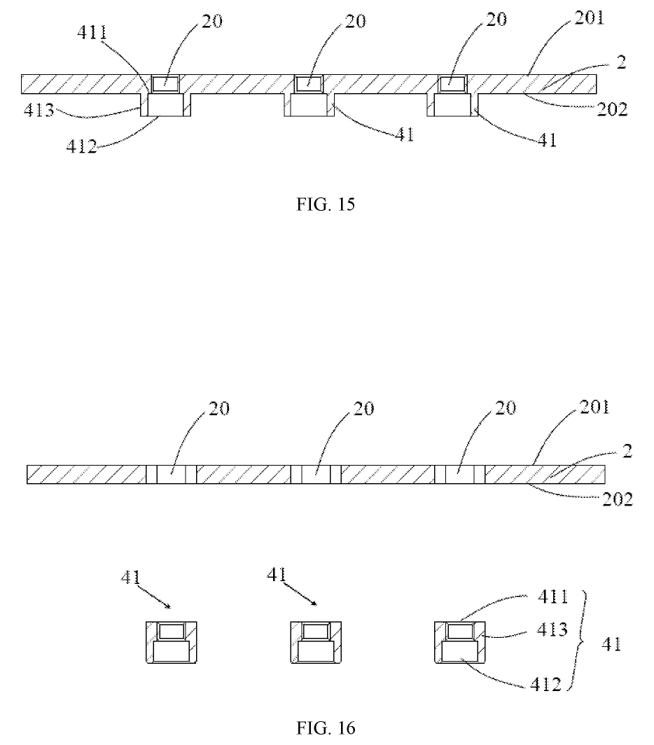

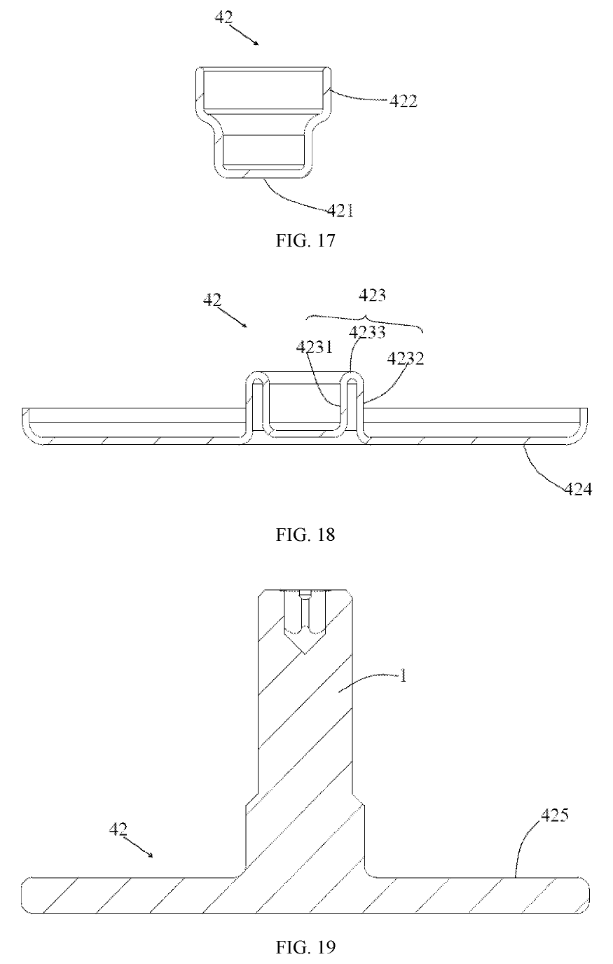

Referring to FIGS. 15-16, which illustrate a first implementation mode and a second implementation mode of the first component 41 in the RF regulating structure of the present disclosure; Referring to FIGS. 17-19, which illustrate a first implementation mode, a second implementation mode and a third implementation mode of the second component 42 in the RF regulating structure of the present disclosure. Therefore, it can be understood that the first to sixth embodiments of the RF regulating structure disclosed above are six permutations and combinations based on the first and second embodiments of the first component 41 and the first, second and third embodiments of the second component 42.

Referring to FIGS. 1 to 14, the present disclosure further includes a screw nut 5 secured to the cover plate 2, the adjustable screw rod 1 passes through the screw nut 5 and penetrates into the through hole 20, the adjustable screw rod 1 includes an external thread and the screw nut 5 includes an internal thread, and the adjustable screw rod 1 is adjustably positioned and connected to the cover plate 2 through the cooperation between the internal thread and the external thread. In another implementation mode not shown, the through hole 20 includes an internal thread, the adjustable screw rod 1 includes an external thread, and the adjustable screw rod 1 is adjustably positioned and connected to the cover plate 2 by engagement between the internal thread and the external thread.

In both ways it is possible to position the adjustable screw rod 1 on the cover plate 2 and adjust the depth by means of thread engagement. Therefore, metal wires and metal powder and other debris may be generated when friction occurs in the thread screwing and locking process of the two metal parts of the adjustable screw rod 1 and the cover plate 2 or the three metal parts of the adjustable screw rod 1, the cover plate 2 and the screw nut 5. In the present disclosure, a first component 41 and a second component 42 are additionally provided, the first component 41 has a function of guiding and blocking debris from the through hole 20, and the second component 42 has a function of collecting debris guided from the first component 41, that is, the first component 41 is a debris passage and the second component 42 is a target of debris. Through the cooperation of the first component 41 and the second component 42, debris falling below the cover plate 2 is reduced, the intermodulation is improved, and the frequency modulation effect is optimized.

Referring to FIGS. 3-14, the RF adjusting structure of the present disclosure further includes a resonant rod 6 positioned in the functional cavity 30 and secured to the box base 3, and the resonant rod 6 is secured to a protruding post 31 protruding upward from an inner upper surface of the box base 3 by a screw nail 7. The adjustable screw rod 1 is positioned right above the resonant rod 6. Thus, the frequency of the RF tuning structure can be adjusted by varying the different depths of penetration of the adjustable screw rod 1 under the cover plate 2.

In addition, referring to FIGS. 3 to 14, the adjustable screw rod 1 includes a coupled screw rod 8 offset from the resonant rod 6 in addition to the adjustable screw rod 1 located directly above the resonant rod 6. The coupled screw rod 8 is also adjustable in frequency by protruding to different depths under the cover plate 2, also generating debris between the helically positioned threads. Therefore, the first component 41 and the second component 42 can also be sleeved on the part of the coupled screw rod 8 protruding into the functional chamber 30. However, since there is no resonant rod 6 below the coupled screw rod 8 and the bottom of the functional cavity 30, i.e., the inner upper surface of the box base 3, corresponds to the bottom of the functional cavity 30, the second component 42 of the coupled screw rod 8 may not have a disk-like part, and the disk-like part refers to the round plate portion 424 in the third and fourth embodiments and the debris-blocking flat portion 425 in the fifth and sixth embodiments. The reverse can be understood to be the role played by the disc in the third to sixth embodiments, more to reduce debris falling into the resonant rod 6. Therefore, since the round plate portion 424 is provided in the third and fourth embodiments and the debris-blocking flat portion 425 is provided in the fifth and sixth embodiments, compared with the first and second embodiments, the short circuit phenomenon between the adjustable screw rod 1 and the resonant rod 6 caused by metal debris can be reduced better.

In summary, the present disclosure adds a debris collector 4, which includes a first component 41 and a second component 42, wherein the first component 41 has the function of guiding and obstructing debris from the through hole 20, and the second component 42 has the function of collecting debris guided from the first component 41, that is, the first component 41 is a debris passage and the second component 42 is a target of debris. Through the cooperation of the first component 41 and the second component 42, debris falling below the cover plate 2 is reduced, the intermodulation is improved, and the frequency modulation effect is optimized.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A radio frequency adjustment structure, comprising:
a box base;
a cover plate covering the box base to define a functional cavity between the cover plate and the box base, the cover plate comprising a top surface facing away from the functional cavity and a bottom surface facing the functional cavity for defining a vertical direction, the cover plate defining a through hole communicating the top surface with the bottom surface along the vertical direction;
an adjustable screw rod being positioned to the cover plate, penetrating through the through hole, and partially extending into the functional cavity; and
a debris collector comprising a first component and a second component, the first component being disposed at a position corresponding to the through hole of the cover plate and extending beyond the bottom surface toward the functional cavity, the first component surrounding the adjustable screw rod, and the second component being disposed just below the first component in the functional cavity.

2. The radio frequency adjustment structure according to claim 1, wherein the first component comprises a sidewall annular portion, the sidewall annular portion defines a top opening and a bottom opening opposite to the top opening, and the sidewall annular portion comprises an upper portion adjacent to the top opening and a lower portion adjacent to the bottom opening.

3. The radio frequency adjustment structure according to claim 2, wherein the first component and the cover plate are integrally molded and the sidewall annular portion entirely protrudes directly from the bottom surface toward the functional cavity.

4. The radio frequency adjustment structure according to claim 2, wherein the first component and the cover plate are separately molded, the upper portion of the sidewall annular portion is press-riveted into the through hole, while the lower portion of the sidewall annular portion is exposed out of the through hole and disposed toward the functional cavity from the bottom surface.

5. The radio frequency adjustment structure according to claim 2, wherein the adjustable screw rod comprises a distal end portion and the second component is connected to the distal end portion.

6. The radio frequency adjustment structure according to claim 5, wherein the second component is fixedly connected to the distal end portion and the second component is partially inserted into the bottom opening.

7. The radio frequency adjustment structure according to claim 6, wherein the second component comprises a bottom bowl portion and an annular sidewall portion extending upward from a top edge of the bottom bowl portion, the annular sidewall portion is spaced apart from the adjustable screw rod and is maintained in close contact with the sidewall annular portion.

8. The radio frequency adjustment structure according to claim 7, wherein the bottom bowl portion wraps around the end portion and the bottom bowl portion is secured to the end portion by welding.

9. The radio frequency adjustment structure according to claim 6, wherein the second component comprises an annular protrusion portion located at a central thereof and a round plate portion extending outward from a bottom end of the annular protrusion portion, the annular protrusion portion comprises an inner annual wall, an outer annual wall and an arc-shaped portion, a top end of the inner annual wall and a top end of the outer annual wall are connected by the arc-shaped portion, and the round plate portion is connected to the outer annual wall.

10. The radio frequency adjustment structure according to claim 9, wherein the inner annual wall is maintained in contact with the outer wall surface of the adjustable screw rod and the outer annual wall is maintained in contact with the inner wall surface of the top opening.

11. The radio frequency adjustment structure according to claim 5, wherein the second component is integrally connected with the terminal portion, the second component is a debris-blocking flat portion integrally stamped from the terminal portion, and the debris-blocking flat portion is spaced below the bottom opening.

12. The radio frequency adjustment structure according to claim 1, wherein the through hole comprises an internal thread, the adjustable screw rod comprises an external thread, and the adjustable screw rod is adjustably and fixedly coupled to the cover plate through the cooperation of the internal thread and the external thread.

13. The radio frequency adjustment structure according to claim 1, further comprising a screw nut secured onto the cover plate, wherein the adjustable screw rod passes through the screw nut and extends into the through hole, the adjustable screw rod comprises an external thread, the screw nut comprises an internal thread, and the adjustable screw rod is adjustably and fixedly coupled to the cover plate through the cooperation of the internal thread and the external thread.

14. The radio frequency adjustment structure according to claim 1, further comprising a resonant rod, wherein the resonant rod is located in the functional cavity and secured to the box base, and the adjustable screw rod is located directly above the resonant rod.

15. A radio frequency adjustment structure, comprising:
a cover plate, the cover plate comprising a top surface and a bottom surface oppositely facing in a vertical direction, the cover plate defining a through hole communicating the top surface with the bottom surface along the vertical direction;
an adjustable screw rod being positioned to the cover plate and penetrating through the through hole by means of partially extending beyond the top surface and partially extending below the bottom surface; and
a debris collection component comprising a first component and a second component, the first component being disposed at a circular position surrounding the through hole of the cover plate, the first component being exposed out of the bottom surface of the cover plate and the second component being disposed below the first component in the vertical direction.

16. The radio frequency adjustment structure according to claim 15, further comprising a box base; wherein the cover plate covers the box base to define a functional cavity between the cover plate and the box base.

17. The radio frequency adjustment structure according to claim 16, wherein the first component surrounds the adjustable screw rod in the functional cavity.

18. The radio frequency adjustment structure according to claim 15, wherein the through hole comprises an internal thread, the adjustable screw rod comprises an external thread, and the adjustable screw rod is adjustably and fixedly coupled to the cover plate through the cooperation of the internal thread and the external thread.

19. The radio frequency adjustment structure according to claim 15, further comprising a screw nut secured onto the cover plate, wherein the adjustable screw rod passes through the screw nut and extends into the through hole, the adjustable screw rod comprises an external thread, the screw nut comprises an internal thread, and the adjustable screw rod is adjustably and fixedly coupled to the cover plate through the cooperation of the internal thread and the external thread.

20. The radio frequency adjustment structure according to claim 16, further comprising a resonant rod, wherein the resonant rod is located in the functional cavity and secured to the box base, and the adjustable screw rod is located directly above the resonant rod.
